(19) United States
(12) Patent Application Publication
(10) Pub. No.: US 2026/0323608 A1
(43) Pub. Date: Oct. 15, 2026

(54) METHOD AND APPARATUS FOR SCHEDULING REQUEST ENHANCEMENT IN MOBILE COMMUNICATIONS

(71) Applicant: MediaTek Singapore Pte. Ltd., Singapore (SG)

(72) Inventors: Abdulhamed Khaled E WARAIET, Cambridge (GB); Sumaila Anning MAHAMA, Cambridge (GB); Mohammed S Aleabe AL-IMARI, Cambridge (GB)

(73) Assignee: MediaTek Singapore Pte. Ltd., Singapore (SG)

(21) Appl. No.: 19/473,896

(22) PCT Filed: Sep. 19, 2024
(86) PCT No.: PCT/CN2024/119574

§ 371 Date: Oct. 9, 2025

Related U.S. Application Data
(60) Provisional application No. 63/596,328, filed on Nov. 6, 2023.

(51) Int. Cl. H04W 72/0446; H04W 72/542

(52) U.S. Cl. CPC H04W 72/0446; H04W 72/542

(57) ABSTRACT

Various solutions for scheduling request (SR) enhancement with respect to an apparatus in mobile communications are described. The apparatus may receive an SR configuration from a network node. The SR configuration may indicate a first SR transmitting allocation and a second SR transmitting allocation different from the first SR transmitting allocation. The apparatus may transmit an SR to the network node based on at least one of the first SR transmitting allocation and the second SR transmitting allocation.

### CROSS REFERENCE TO RELATED PATENT APPLICATION(S)

The present disclosure is part of a non-provisional application claiming the priority benefit of U.S. Patent Application No. 63/596,328, filed 6 Nov. 2023, the content of which herein being incorporated by reference in its entirety.

### TECHNICAL FIELD

The present disclosure is generally related to mobile communications and, more particularly, to scheduling request enhancement with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, scheduling request (SR) enables user equipment (UE) to request uplink (UL) grant from network for data transmission. More specifically, the SR is a special physical layer message from the UE asking the network for an UL grant to transmit physical uplink shared channel (PUSCH), and the SR indicates that the UE has pending data to transmit and requests the necessary network resources.

In some scenarios, the SR is dynamically triggered by the UE when the UE has data to transmit but lacks an UL grant from the network, which may suffer significant scheduling latencies. For example, the scheduling latencies may be impacted by the frequency of SR occasions (i.e., SR periodicity), the frequency of physical downlink control channel (PDCCH) occasions (i.e., PDCCH periodicity), the UL and downlink (DL) processing delays, etc.

However, the scheduling latencies depend on various factors, such as network conditions, processing capabilities and scheduling algorithms, and the scheduling latencies of SR are critical parameters that influence the performance and responsiveness of the overall network. Accordingly, how to reduce the scheduling latencies of SR becomes an important issue in the newly developed wireless communication network. Therefore, there is a need to provide proper schemes to reduce the scheduling latencies of SR.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to scheduling request (SR) enhancement with respect to apparatus in mobile communications.

In one aspect, a method may involve an apparatus receiving an SR configuration from a network node. The SR configuration may indicate a first SR transmitting allocation and a second SR transmitting allocation different from the first SR transmitting allocation. The method may also involve the apparatus transmitting an SR to the network node based on at least one of the first SR transmitting allocation and the second SR transmitting allocation.

In one aspect, a method may involve an apparatus transmitting an SR configuration to a UE. The SR configuration may indicate a first SR transmitting allocation and a second SR transmitting allocation different from the first SR transmitting allocation. The method may also involve the apparatus receiving an SR from the UE based on at least one of the first SR transmitting allocation and the second SR transmitting allocation.

In one aspect, an apparatus may comprise a transceiver which, during operation, wirelessly communicates with a wireless network. The apparatus may also comprise a processor communicatively coupled to the transceiver. The processor, during operation, may perform operations comprising receiving, via the transceiver, an SR configuration from a network node. The SR configuration may indicate a first SR transmitting allocation and a second SR transmitting allocation different from the first SR transmitting allocation. The processor may also perform operations comprising transmitting an SR to the network node based on at least one of the first SR transmitting allocation and the second SR transmitting allocation.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IOT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to scheduling request (SR) enhancement with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may determine an SR configuration, and transmit the SR configuration to a user equipment (UE). The SR configuration may include some parameters indicating at least two different SR transmitting allocations. After receiving the SR configuration, the UE may apply the SR configuration, and transmit an SR to the network node based on at least one of the SR transmitting allocations. The network may receive the SR from the UE based on at least one of the SR transmitting allocations.

More specifically, one SR transmitting allocation may have a dense SR periodicity, while the other SR transmitting allocation may have a sparse SR periodicity. Therefore, depending on various network scenarios, both the network and the UE may employ different SR allocations for transmitting SR, which may reduce scheduling latencies, such as those associated with the frequency of SR occasions.

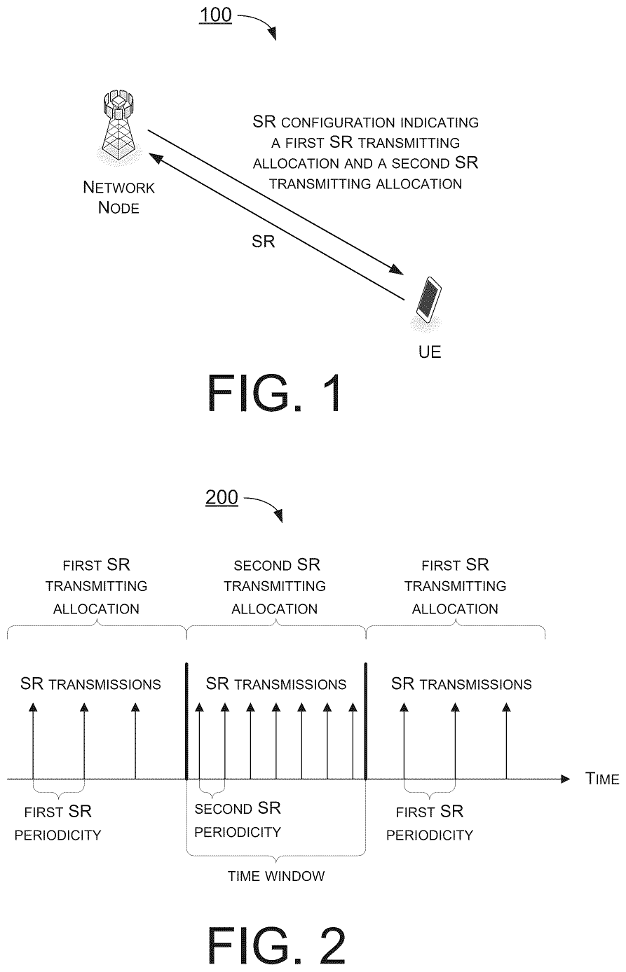

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the network may determine an SR configuration. The SR configuration may indicate a first SR transmitting allocation and a second SR transmitting allocation. The first SR transmitting allocation may be different from the second SR transmitting allocation. The network node may transmit the SR configuration to the UE. After receiving the SR configuration, the UE may apply the SR configuration. Accordingly, when the UE needs to request uplink (UL) grant from the network for data transmission, the UE may transmit an SR to the network node based on at least one of the first SR transmitting allocation and the second SR transmitting allocation.

FIG. 2 illustrates an example scenario 200 under schemes in accordance with implementations of the present disclosure. In some implementations, the SR configuration may be included in a higher layer singling (e.g., radio resource control (RRC) configuration). The SR configuration may include a first SR periodicity, a second SR periodicity and a time window.

The first SR transmitting allocation may include the first SR periodicity outside the time window. More specifically, based on the first SR transmitting allocation, the UE may transmit the SR according to the first SR periodicity outside the time window. The second SR transmitting allocation may include the second SR periodicity within the time window. More specifically, based on the second SR transmitting allocation, the UE may transmit the SR according to the second SR periodicity within the time window. It should be noted that, in FIG. 2, each arrow line may represent an SR occasion for transmitting the SR. However, it is not intended to limit the number of SR transmissions.

Therefore, the UE may transmit the SR to the network node based on at least one of the first SR transmitting allocation and the second SR transmitting allocation. More specifically, outside the time window, the UE may transmit the SR based on the first SR periodicity, while within the time window, the UE may transmit the SR based on the second SR periodicity.

For example, a time window parameter of the SR configuration defines a timing position of the time window. The time window is defined according to (e.g., to be coincided with) a rate of packet arrival in data buffer of the UE so that the time window is used for transmitting the SR associated with UL transmission of the packet arrival in data buffer of the UE. A first SR parameter of the SR configuration defines the first SR periodicity and a first offset. The first offset is used for aligning the first SR transmission outside the time window. A second SR parameter of the SR configuration defines the second SR periodicity and a second offset. The second offset is used for aligning the first SR transmission within the time window. The UE applies the first SR periodicity for transmitting the SR outside the time window and applies the second SR periodicity for transmitting the SR within the time window. The second SR periodicity is shorter than the first SR periodicity. In other words, comparing to the first SR periodicity, the second SR periodicity has a shorter duration which enables more frequent SR transmission.

Accordingly, regarding the first SR transmitting allocation, the UE is configured to transmit the SR based on the first SR periodicity outside the time window. Because the first SR periodicity is sparser, resulting in longer latency, the first SR transmitting allocation is applied for an application with less latency sensitive (e.g., voice application). Regarding the second SR transmitting allocation, the UE is configured to transmit the SR based on the second SR periodicity within the time window. Because the second SR periodicity is denser, resulting in shorter latency, the second SR transmitting allocation is applied for an application with more latency sensitive (e.g., XR application).

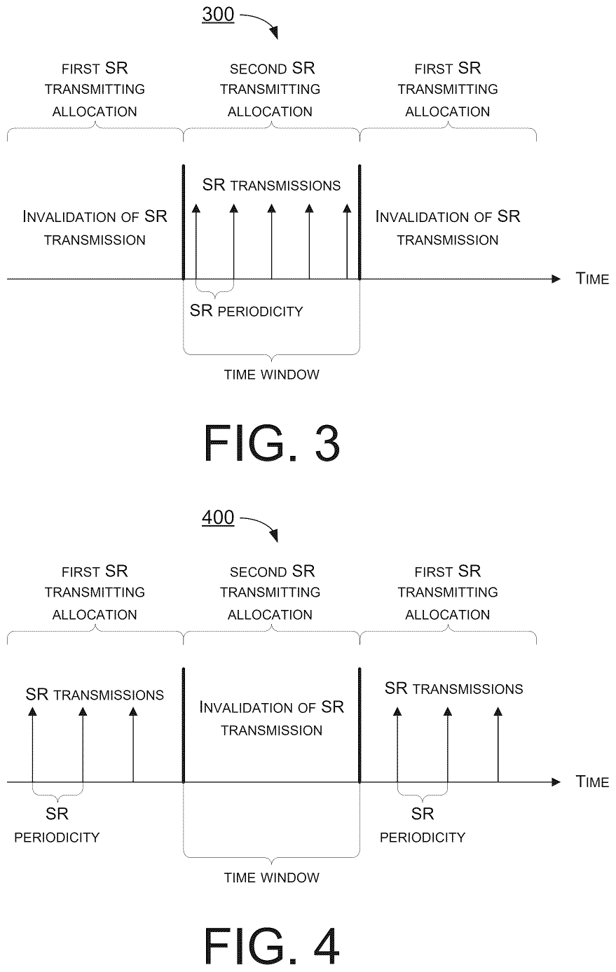

FIG. 3 illustrates an example scenario 300 under schemes in accordance with implementations of the present disclosure. In some implementations, the SR configuration may be included in a higher layer singling (e.g., RRC configuration). The SR configuration may include an SR periodicity and a time window.

The first SR transmitting allocation may include an invalidation of transmitting the SR outside the time window. More specifically, based on the first SR transmitting allocation, the UE may not transmit the SR outside the time window. The second SR transmitting allocation may include the SR periodicity within the time window. More specifically, based on the second SR transmitting allocation, the UE may transmit the SR according to the SR periodicity within the time window. It should be noted that, in FIG. 3, each arrow line may represent an SR occasion for transmitting the SR. However, it is not intended to limit the number of SR transmissions.

Therefore, the UE may transmit the SR to the network node based on the second SR transmitting allocation. More specifically, outside the time window, the UE may not transmit the SR, while within the time window, the UE may transmit the SR based on the SR periodicity.

For example, a time window parameter of the SR configuration defines a timing position of the time window. The time window is defined according to (e.g., to be coincided with) a rate of packet arrival in data buffer of the UE so that the time window is used for transmitting the SR associated with UL transmission of the packet arrival in data buffer of the UE. An SR parameter of the SR configuration defines the SR periodicity and an offset. The offset is used for aligning the first SR transmission within the time window. The UE applies the SR periodicity for transmitting the SR within the time window.

Accordingly, regarding the first SR transmitting allocation, the UE is configured not to transmit the SR outside the time window. Regarding the second SR transmitting allocation, the UE is configured to transmit the SR based on the SR periodicity within the time window.

FIG. 4 illustrates an example scenario 400 under schemes in accordance with implementations of the present disclosure. In some implementations, the SR configuration may be included in a layer-1 singling (e.g., downlink control information (DCI)). The SR configuration may include an SR periodicity and a time window.

The first SR transmitting allocation may include the SR periodicity outside the time window. More specifically, based on the first SR transmitting allocation, the UE may transmit the SR according to the SR periodicity outside the time window. The second SR transmitting allocation may include an invalidation of transmitting the SR within the time window. More specifically, based on the second SR transmitting allocation, the UE may not transmit the SR within the time window. It should be noted that, in FIG. 4, each arrow line may represent an SR occasion for transmitting the SR. However, it is not intended to limit the number of SR transmissions.

Therefore, the UE may transmit the SR to the network node based on the first SR transmitting allocation. More specifically, within the time window, the UE may not transmit the SR, while outside the time window, the UE may transmit the SR based on the SR periodicity.

For example, a time window parameter of the SR configuration defines a timing position of the time window. One or more timing positions outside the time window are defined according to (e.g., to be coincided with) a rate of packet arrival in data buffer of the UE so that one or more timing positions outside the time window are used for transmitting the SR associated with UL transmission of the packet arrival in data buffer of the UE. In some cases, the absence of the time window parameter indicates that the function of disabling SR transmission is not supported. In other words, the presence of the time window parameter indicates that the function of disabling SR transmission is supported. In some cases, when a value of the time window parameter is equal to zero, the function of disabling SR transmission is not supported. In some cases, when a value of the time window parameter is not equal to zero (e.g., greater than zero), the function of disabling SR transmission is supported. An SR parameter of the SR configuration defines the SR periodicity and an offset. The offset is used for aligning the first SR transmission within the time window. The UE applies the SR periodicity for transmitting the SR within the time window.

Accordingly, regarding the first SR transmitting allocation, the UE is configured to transmit the SR based on the SR periodicity outside the time window. Regarding the second SR transmitting allocation, the UE is configured not to transmit the SR within the time window.

### Illustrative Implementations

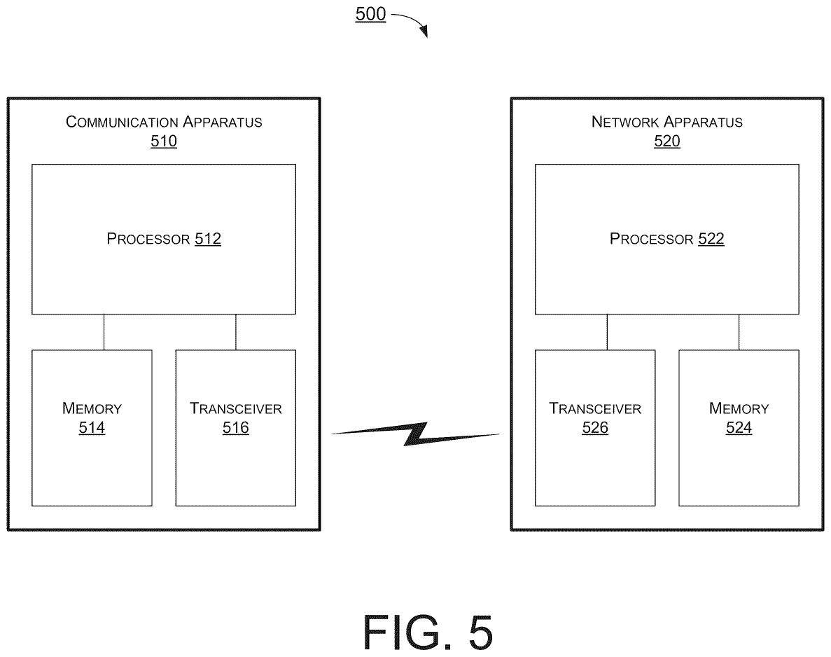

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to SR enhancement with respect to UE and network apparatus in mobile communications, including scenarios/schemes described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of a network apparatus, which may be a network node such as a satellite, a base station, a small cell, a router or a gateway. For instance, network apparatus 520 may be implemented in an eNodeB in an LTE network, in a gNB in a 5G/NR, IoT, NB-IoT or IIoT network or in a satellite or base station in a 6G network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including SR enhancements in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In other words, processor 512 may transceive the data such as configuration, message, signal, information, indicator, etc. via transceiver 516. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data. In other words, processor 522 may transceive the data such as configuration, message, signal, information, indicator, etc. via transceiver 526. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively. To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE and network apparatus 520 is implemented in or as a network node of a communication network.

In some implementations, each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

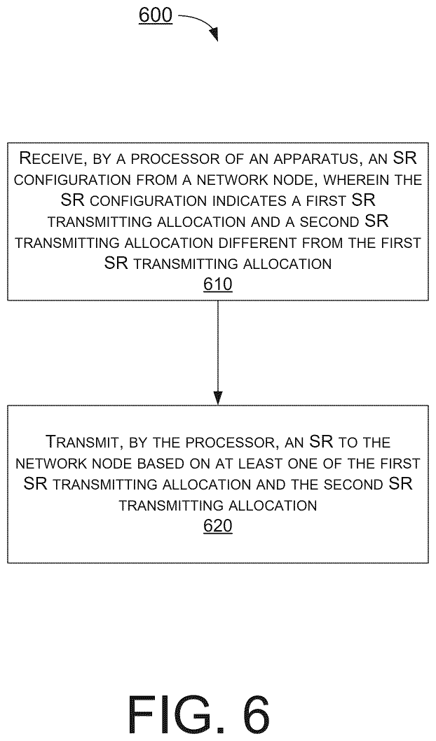

FIG. 6 illustrates an example process 600 in accordance with an implementation of the present disclosure. Process 600 may be an example implementation of above scenarios/schemes, whether partially or completely, with respect to SR enhancement of the present disclosure. Process 500 may represent an aspect of implementation of features of communication apparatus 510. Process 600 may include one or more operations, actions, or functions as illustrated by one or more of blocks 610 to 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510. Process 600 may begin at block 610.

At block 610, process 600 may involve processor 512 of communication apparatus 510 receiving an SR configuration from a network node. The SR configuration may indicate a first SR transmitting allocation and a second SR transmitting allocation different from the first SR transmitting allocation. Process 600 may proceed from block 610 to block 620.

At block 620, process 600 may involve processor 512 of communication apparatus 510 transmitting an SR to the network node based on at least one of the first SR transmitting allocation and the second SR transmitting allocation.

In some implementations, the SR configuration may include a first SR periodicity, a second SR periodicity and a time window. The first SR transmitting allocation may include the first SR periodicity outside the time window. The second SR transmitting allocation may include the second SR periodicity within the time window. The step of transmitting the SR to the network node based on at least one of the first SR transmitting allocation and the second SR transmitting allocation may further include: transmitting the SR to the network node based on the first SR periodicity outside the time window or based on the second SR periodicity within the time window.

In some implementations, the time window may be configured according to (e.g., to be coincided with) a rate of packet arrival.

In some implementations, the SR configuration may be included in a higher layer signaling.

In some implementations, the SR configuration may include an SR periodicity and a time window. The first SR transmitting allocation may include an invalidation of transmitting the SR outside the time window. The second SR transmitting allocation may include the SR periodicity within the time window. The step of transmitting the SR to the network node based on at least one of the first SR transmitting allocation and the second SR transmitting allocation may further include: transmitting the SR based on the SR periodicity within the time window.

In some implementations, the time window may be configured according to (e.g., to be coincided with) a rate of packet arrival.

In some implementations, the SR configuration may be included in a higher layer signaling.

In some implementations, the SR configuration may include an SR periodicity and a time window. The first SR transmitting allocation may include the SR periodicity outside the time window. The second SR transmitting allocation may include an invalidation of transmitting the SR within the time window. The step of transmitting the SR to the network node based on at least one of the first SR transmitting allocation and the second SR transmitting allocation may further include: transmitting the SR based on the SR periodicity outside the time window.

In some implementations, the SR configuration may be included in a layer-1 signaling.

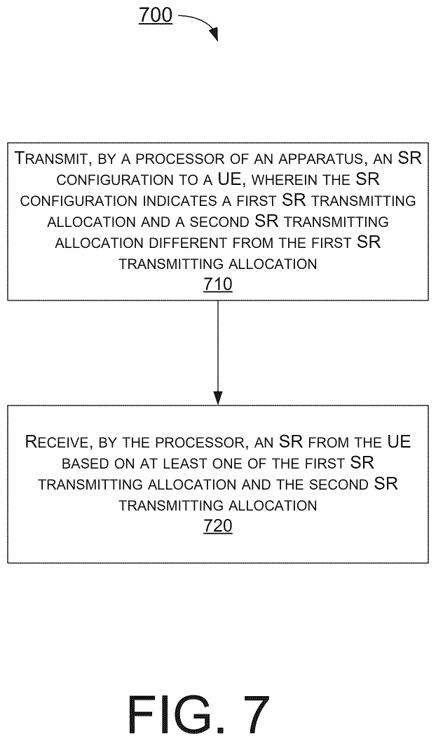

FIG. 7 illustrates an example process 700 in accordance with an implementation of the present disclosure. Process 700 may be an example implementation of above scenarios/schemes, whether partially or completely, with respect to SR enhancement of the present disclosure. Process 700 may represent an aspect of implementation of features of network apparatus 520. Process 700 may include one or more operations, actions, or functions as illustrated by one or more of blocks 710 to 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by network apparatus 520 or any suitable network device or machine type devices. Solely for illustrative purposes and without limitation, process 700 is described below in the context of network apparatus 520. Process 700 may begin at block 710.

At block 710, process 700 may involve processor 522 of network apparatus 520 transmitting an SR configuration to a UE. The SR configuration may indicate a first SR transmitting allocation and a second SR transmitting allocation different from the first SR transmitting allocation. Process 700 may proceed from block 710 to block 720.

At block 720, process 700 may involve processor 522 of network apparatus 520 receiving an SR from the UE based on at least one of the first SR transmitting allocation and the second SR transmitting allocation.

In some implementations, the SR configuration may include a first SR periodicity, a second SR periodicity and a time window The first SR transmitting allocation may include the first SR periodicity outside the time window. The second SR transmitting allocation may include the second SR periodicity within the time window. The step of receiving the SR from the UE based on at least one of the first SR transmitting allocation and the second SR transmitting allocation may further include: receiving the SR based on the first SR periodicity outside the time window or based on the second SR periodicity within the time window.

In some implementations, the time window may be configured according to (e.g., to be coincided with) a rate of packet arrival.

In some implementations, the SR configuration may be included in a higher layer signaling.

In some implementations, the SR configuration may include an SR periodicity and a time window. The first SR transmitting allocation may include an invalidation of transmitting the SR outside the time window. The second SR transmitting allocation may include the SR periodicity within the time window. The step of receiving the SR from the UE based on at least one of the first SR transmitting allocation and the second SR transmitting allocation may further include: receiving the SR based on the SR periodicity within the time window.

In some implementations, the time window may be configured according to (e.g., to be coincided with) a rate of packet arrival.

In some implementations, the SR configuration may be included in a higher layer signaling.

In some implementations, the SR configuration may include an SR periodicity and a time window. The first SR transmitting allocation may include the SR periodicity outside the time window. The second SR transmitting allocation may include an invalidation of transmitting the SR within the time window. The step of receiving the SR from the UE based on at least one of the first SR transmitting allocation and the second SR transmitting allocation may further include: receiving the SR based on the SR periodicity outside the time window.

In some implementations, the SR configuration may be included in a layer-1 signaling.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a scheduling request (SR) configuration from a network node, wherein the SR configuration indicates a first SR transmitting allocation and a second SR transmitting allocation different from the first SR transmitting allocation; and
transmitting, by the processor, an SR to the network node based on at least one of the first SR transmitting allocation and the second SR transmitting allocation.

2. The method of claim 1, wherein the SR configuration includes a first SR periodicity, a second SR periodicity and a time window, the first SR transmitting allocation includes the first SR periodicity outside the time window, the second SR transmitting allocation includes the second SR periodicity within the time window, and the step of transmitting the SR to the network node based on at least one of the first SR transmitting allocation and the second SR transmitting allocation further includes:
transmitting the SR to the network node based on the first SR periodicity outside the time window or based on the second SR periodicity within the time window.

3. The method of claim 2, wherein the time window is configured according to a rate of packet arrival.

4. The method of claim 2, wherein the SR configuration is included in a higher layer signaling.

5. The method of claim 1, wherein the SR configuration includes an SR periodicity and a time window, the first SR transmitting allocation includes an invalidation of transmitting the SR outside the time window, the second SR transmitting allocation includes the SR periodicity within the time window, and the step of transmitting the SR to the network node based on at least one of the first SR transmitting allocation and the second SR transmitting allocation further includes:
transmitting the SR based on the SR periodicity within the time window.

6. The method of claim 5, wherein the time window is configured according to a rate of packet arrival.

7. The method of claim 5, wherein the SR configuration is included in a higher layer signaling.

8. The method of claim 1, wherein the SR configuration includes an SR periodicity and a time window, the first SR transmitting allocation includes the SR periodicity outside the time window, the second SR transmitting allocation includes an invalidation of transmitting the SR within the time window, and the step of transmitting the SR to the network node based on at least one of the first SR transmitting allocation and the second SR transmitting allocation further includes:
transmitting the SR based on the SR periodicity outside the time window.

9. The method of claim 8, wherein the SR configuration is included in a layer-1 signaling.

10. A method, comprising:
transmitting, by a processor of an apparatus, a scheduling request (SR) configuration to a user equipment (UE), wherein the SR configuration indicates a first SR transmitting allocation and a second SR transmitting allocation different from the first SR transmitting allocation; and
receiving, by the processor, an SR from the UE based on at least one of the first SR transmitting allocation and the second SR transmitting allocation.

11. The method of claim 10, wherein the SR configuration includes a first SR periodicity, a second SR periodicity and a time window, the first SR transmitting allocation includes the first SR periodicity outside the time window, the second SR transmitting allocation includes the second SR periodicity within the time window, and the step of receiving the SR from the UE based on at least one of the first SR transmitting allocation and the second SR transmitting allocation further includes:
receiving the SR based on the first SR periodicity outside the time window or based on the second SR periodicity within the time window.

12. The method of claim 11, wherein the time window is configured according to a rate of packet arrival.

13. The method of claim 11, wherein the SR configuration is included in a higher layer signaling.

14. The method of claim 10, wherein the SR configuration includes an SR periodicity and a time window, the first SR transmitting allocation includes an invalidation of transmitting the SR outside the time window, the second SR transmitting allocation includes the SR periodicity within the time window, and the step of receiving the SR from the UE based on at least one of the first SR transmitting allocation and the second SR transmitting allocation further includes:
receiving the SR based on the SR periodicity within the time window.

15. The method of claim 14, wherein the time window is configured according to a rate of packet arrival.

16. The method of claim 14, wherein the SR configuration is included in a higher layer signaling.

17. The method of claim 10, wherein the SR configuration includes an SR periodicity and a time window, the first SR transmitting allocation includes the SR periodicity outside the time window, the second SR transmitting allocation includes an invalidation of transmitting the SR within the time window, and the step of receiving the SR from the UE based on at least one of the first SR transmitting allocation and the second SR transmitting allocation further includes:
receiving the SR based on the SR periodicity outside the time window.

18. The method of claim 8, wherein the SR configuration is included in a layer-1 signaling.

19. An apparatus, comprising:
a transceiver which, during operation, wirelessly communicates with a wireless network; and
a processor communicatively coupled to the transceiver such that, during operation, the processor performs operations comprising:
receiving, via the transceiver, a scheduling request (SR) configuration from a network node, wherein the SR configuration indicates a first SR transmitting allocation and a second SR transmitting allocation different from the first SR transmitting allocation; and
transmitting, via the transceiver, an SR to the network node based on at least one of the first SR transmitting allocation and the second SR transmitting allocation.

20. The apparatus of claim 19, wherein the SR configuration includes a first SR periodicity and a second SR periodicity, and the second SR periodicity is shorter than the first SR periodicity.
